(19) United States
(12) Patent Application Publication
(10) Pub. No.: US 2026/0112986 A1
(43) Pub. Date: Apr. 23, 2026

(54) DRIVE DEVICE

(71) Applicant: TOYOTA JIDOSHA KABUSHIKI KAISHA, Toyota-shi (JP)

(72) Inventors: Toshihiro YAMAMOTO, Toyohashi-shi (JP); Takahiro HIMENO, Toyota-shi (JP); Toshifumi YAMAKAWA, Okazaki-shi (JP)

(73) Assignee: TOYOTA JIDOSHA KABUSHIKI KAISHA, Toyota-shi (JP)

(21) Appl. No.: 19/238,896

(22) Filed: Jun. 16, 2025

(30) Foreign Application Priority Data
Oct. 17, 2024 (JP) 2024-182247

(51) Int. Cl. H02P 21/20; H02P 21/22; H02P 27/06

(52) U.S. Cl. CPC H02P 21/20; H02P 21/22; H02P 27/06

(57) ABSTRACT

The drive device includes a motor, an inverter that drives the motor, and a control device that sets an effective current command based on a torque command of the motor, a rotational speed, and a DC-side voltage of the inverter, sets a voltage phase command using feedback control for canceling a difference between the effective current command and the effective current, and controls the inverter by rectangular wave control. The control device sets the control power factor by guarding the power factor based on the current phase and the voltage phase at the lower limit of the allowable power factor, and calculates the effective current as a product of the current amplitude based on the current of the d-axis and the q-axis and the control power factor.

### CROSS-REFERENCE TO RELATED APPLICATION

This application claims priority to Japanese Patent Application No. 2024-182247 filed on Oct. 17, 2024. The disclosure of the above-identified application, including the specification, drawings, and claims, is incorporated by reference herein in its entirety.

### BACKGROUND

### 1. Technical Field

The present disclosure relates to a drive device.

### 2. Description of Related Art

Conventionally, there has been proposed a drive device including a motor and an inverter that drives the motor, the drive device executing feedback control through rectangular wave control in which a rectangular wave voltage based on a voltage phase command is applied (see Japanese Patent No. 7435189 (JP 7435189 B)). In the feedback control, the voltage phase command is adjusted using the deviation between the product of a current amplitude command and a power factor command and the product of the actual value of the current amplitude and the actual value of the power factor. In this drive device, the rotation speed of the motor is calculated using the rotational angle of the motor. Then, the current amplitude command and the power factor command are calculated using the torque command and the rotational speed of the motor and the direct current (DC)-side voltage of the inverter. Further, the actual value of the current amplitude and the current phase are calculated using the rotational angle and the current of the motor. As a result, the actual value of the power factor is calculated using the deviation between the current phase and the voltage phase command.

### SUMMARY

In such a drive device, the actual value of the power factor tends to decrease as the temperature of the motor increases. Therefore, when the actual value of the power factor becomes sufficiently low, the current amplitude becomes sufficiently large for feedback control, and the degree of overheating of the motor (demagnetization of a permanent magnet of the motor) may be increased.

The drive device according to the present disclosure has a main object of suppressing the degree of overheating of a motor (demagnetization of a permanent magnet of the motor).

In order to achieve the above main object, the drive device according to the present disclosure adopts the following measures.

An aspect of the present disclosure provides a drive device including:
a motor;
an inverter that drives the motor; and
a control device that controls the inverter through rectangular wave control by setting an effective current command based on a torque command and a rotational speed of the motor and a direct current-side voltage of the inverter and setting a voltage phase command using feedback control for canceling out a difference between the effective current command and an effective current, in which
the control device sets a control power factor by guarding a lower limit of a power factor based on a current phase and a voltage phase using an allowable lower limit power factor, and calculates the effective current as a product of a current amplitude based on d-axis and q-axis currents and the control power factor.

In the drive device according to the present disclosure, an effective current command is set based on the torque command and the rotational speed of the motor and the direct current-side voltage of the inverter. Then, a voltage phase command is set using feedback control for canceling out a difference between the effective current command and the effective current. In this way, the inverter is controlled through rectangular wave control. In this case, a control power factor is set by guarding a lower limit of the power factor based on the current phase and the voltage phase using an allowable lower limit power factor, and the effective current is calculated as the product of the current amplitude based on the d-axis and q-axis currents and the control power factor. By setting the control power factor by guarding the lower limit of the power factor using the allowable lower limit power factor, it is possible to suppress the control power factor becoming sufficiently small, and to suppress the current amplitude becoming sufficiently large for the feedback control. As a result, the degree of overheating of the motor (demagnetization of a permanent magnet of the motor) can be suppressed.

In the drive device according to the present disclosure, the control device may set the allowable lower limit power factor based on a voltage amplitude of the motor based on the direct current-side voltage, the torque command, and the rotational speed. In this way, the allowable lower limit power factor can be set more appropriately.

In the drive device according to the present disclosure, it is assumed that the torque command is Tm*, the rotational speed is Nm, the voltage amplitude of the motor based on the direct current-side voltage is |V|, the effective current command is Ia*, the d-axis and q-axis currents are Id, Iq, the current phase is θi, the voltage phase command is θv*, the power factor is Pf, and the current amplitude is |I|. The control device may calculate the effective current command Ia* according to equation (A), calculate the current phase θi according to equation (B), calculate the power factor Pf according to equation (C), and calculate the current amplitude |I| according to equation (D):

$${Ia}^{*} = 2 π \cdot Nm \cdot {Tm}^{*} / ( 60 \cdot \vert V \vert ) \qquad ( A )$$

$$θ i = {tan}^{- 1} ( Id / Iq ) \qquad ( B )$$

$$Pf = cos ( θ i - previous {θ v}^{*} ) \qquad ( C )$$

$$\vert I \vert = √ ( {Id}^{2} + {I q}^{2} ) \qquad ( D )$$

In the drive device according to the present disclosure, when a torque deviation is larger than a predetermined deviation, the control device may determine demagnetization of a permanent magnet of the motor when the power factor is less than the allowable lower limit power factor. The torque deviation is a value obtained by subtracting torque of the motor from the torque command. In this way, it is possible to detect demagnetization of a permanent magnet of the motor.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle in which a drive device according to an embodiment of the present disclosure is mounted;

FIG. 2 is a flowchart illustrating an exemplary square wave control routine executed by an ECU;

FIG. 3 is an explanatory diagram illustrating an exemplary relation between an induced voltage constant, a power factor, an allowable lower limit power factor, a control power factor, and a current amplitude; and

FIG. 4 is a flowchart illustrating an exemplary diagnostic routine executed by ECU.

### DETAILED DESCRIPTION OF EMBODIMENTS

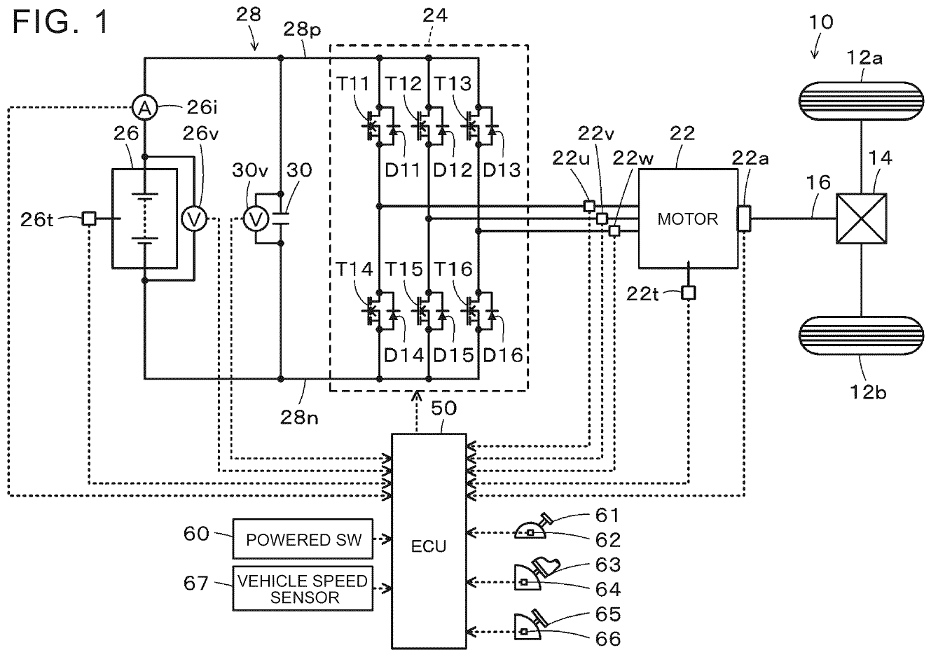

Embodiments for carrying out the present disclosure will be described with reference to the drawings. FIG. 1 is a schematic configuration diagram of a battery electric vehicle 10 in which a drive device according to an embodiment of the present disclosure is mounted. As illustrated, battery electric vehicle 10 of the embodiment includes a motor 22, inverters 24, a battery 26, and an electronic control unit (hereinafter referred to as “ECU”) 50.

The motor 22 is configured as a three-phase AC motor, and has a rotor in which permanent magnets are embedded in the rotor core, and a stator in which three-phase (U-phase, V-phase, and W-phase) coils are wound around the stator core. The rotor of the motor 22 is connected to a drive shaft 16 connected to the drive wheel 12a, 12b via a differential gear 14.

Inverter 24 is connected to power line 28 (positive line 28p and negative line 28n) to which battery 26 is connected. Inverter 24 comprises a transistor T11 to T16 as six switching elements and six diodes D11 to D16 connected in parallel to each of the six transistors T11 to T16. The transistors T11 to T16 are arranged in pairs so as to be on the source-side and the sink-side with respect to the positive line 28p and the negative line 28n, respectively. Each of the connecting points of the two transistors that form the pair of the transistors T11 to T16 is connected to a three-phase (U-phase, V-phase, and W-phase) coil of the motor 22. Therefore, by adjusting the ratio of the on-time of the pair of transistor T11 to T16 by ECU 50, a rotating magnetic field is formed in the three-phase coil of the motor 22, and the motor 22 (rotor) is rotationally driven.

The battery 26 is configured as, for example, a lithium-ion secondary battery or a nickel-hydrogen secondary battery. The positive terminal and the negative terminal of the battery 26 are connected to the power line 28. A smoothing capacitor 30 is connected to the power line 28.

ECU 50 includes a microcomputer, various driving circuitry, and various logic IC. The microcomputer includes a CPU, ROM, RAM, a flash memory, an input/output port, and a communication port. ECU 50 receives signals from various sensors. For example, ECU 50 receives the rotational position θm of the rotor of the motor 22 from the rotational position sensor 22a, the phase current Iu, Iv, Iw of each phase of the motor 22 from the current sensor 22u, 22v, 22w, and the temperature am of the motor 22 from the temperature sensor 22t. ECU 50 also receives the following values: the voltage Vb of the battery 26 from the voltage sensor 26v, the current Ib of the battery 26 from the current sensor 26i, the temperature αb of the battery 26 from the temperature sensor 26t, the voltage VH of the capacitor 30 (power line 28) from the voltage sensor 30v. ECU 50 further receives the following values: an on-off signal from the power switch 60, a shift position SP which is an operating position of the shift lever 61 from the shift position sensor 62, an accelerator operation amount Acc which is a depression amount of the accelerator pedal 63 from the accelerator pedal position sensor 64, a brake pedal position BP which is a depression amount of the brake pedal 65 from the brake pedal position sensor 66, and a vehicle speed v from the vehicle speed sensor 67. ECU 50 outputs a switching control signal to the transistor T11 to T16 of the inverter 24. ECU 50 calculates the electric angle θe and the rotational speed Nm of the motor 22 based on the rotational position θm of the rotor of the motor 22. ECU 50 calculates the power storage ratio SOC of the battery 26 based on the integrated value of the current Ib of the battery 26.

In battery electric vehicle 10 of the embodiment, ECU 50 sets a required torque Td* (required for the drive shaft 16) required for traveling on the basis of the accelerator operation amount Acc and the vehicle speed V. Then, the torque command Tm* of the motor 22 is set so as to travel according to the set required torque Td*, and the switching control of the transistor T11 to T16 of the inverter 24 is performed based on the set torque command Tm*.

ECU 50 selects and executes pulse-width-modulation control (PWM control) or square-wave control as the control of the inverters 24. This selection may be made, for example, based on the modulation factor Rm or based on the torque-command Tm* and the rotational speed Nm. The modulation factor Rm is defined as the ratio of the output voltage (the effective value of the applied voltage of the motor 22) to the input voltage of the inverter 24 (the voltage VH of the capacitor 30). The rectangular wave control will be described below. Since PWM control is not the core of the present disclosure, detailed explanation thereof will be omitted.

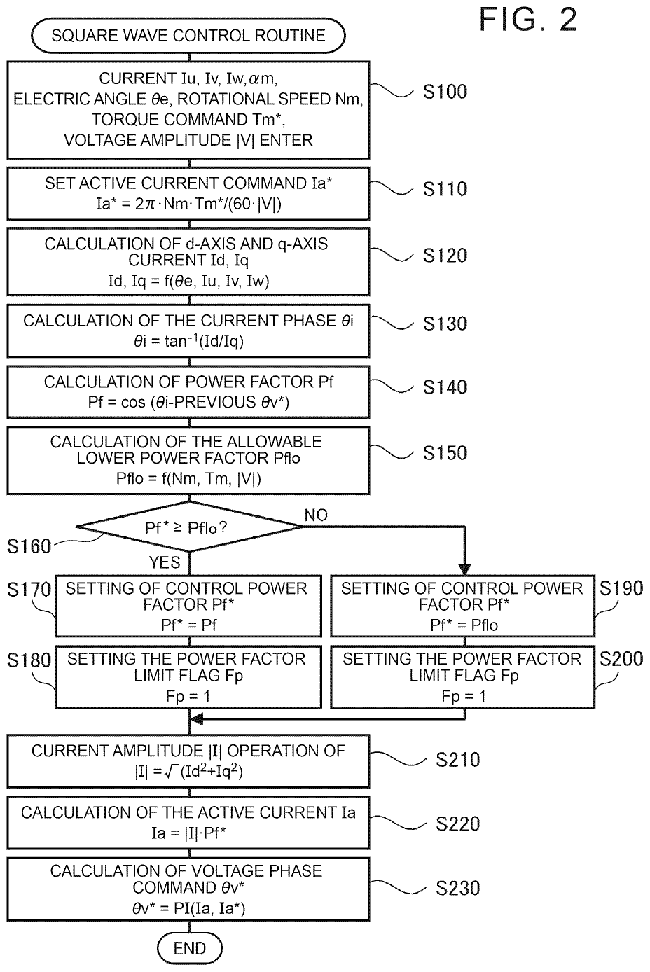

FIG. 2 is a flowchart illustrating an exemplary square-wave control routine executed by ECU 50. This routine is repeatedly executed when the square wave control is selected. When this routine is executed, ECU 50 first enters the phase current Iu, Iv, Iw of each phase of the motor 22, the temperature am, the electric angle θe, the rotational speed Nm, the torque command Tm*, and the voltage amplitude |V| of the applied voltage of the motor 22 (S100). Voltage amplitude |V| Is calculated by multiplying the voltage VH of the capacitor 30 by the modulation factor Rm. In the rectangular-wave control, the modulation factor Rm is determined to be smaller as the number of pulses (the number of times of switching of the transistor T11 to T16) in one cycle of the electric angle θe is larger. The number of pulses may be set as appropriate or may be fixed at a value of 1.

When data is inputted in this way, ECU 50 has a rotational speed Nm, a torque command Tm* and a voltage amplitude V as shown in Equation (1) Used to calculate the valid current command Ia* (S110). Subsequently, the phase current Iu, Iv, Iw of each phase is coordinate-transformed (three-phase-two-phase transformation) using the electric angle θe, and the current Id, Iq of the d-axis and the q-axis is calculated (S120). Then, as shown in Expression (2), the current phase θi is calculated using the calculated current Id, Iq of the d-axis and the q-axis (S130).

$${Ia}^{*} = 2 π \cdot Nm \cdot {Tm}^{*} / ( 60 \cdot \vert V \vert ) \qquad ( 1 )$$

$$θ i = {tan}^{- 1} ( Id / Iq ) \qquad ( 2 )$$

Then, as shown in Expression (3), the power factor Pf is calculated (S140) using the current phase θi and the voltage-phase command (previous θv*) calculated in the previous run of the routine. Then, the rotational speed Nm, the torque command Tm* and the voltage amplitude V| The allowable lower power factor Pflo is set using the lower power factor map and the lower power factor map (S150). Here, the allowable lower limit power factor map includes the rotational speed Nm, the torque command Tm* and the voltage amplitude V. The relation between the lower power factor and the lower power factor Pfl is determined in advance by experimentation, analysis, or the like. In S150 process, the allowable lower limit power factor map includes the rotational speed Nm, the torque command Tm* and the voltage amplitude |V| The allowable lower power factor Pflo is set by applying and deriving the corresponding allowable lower power factor Pflo from the map.

Pf=cos(θi−previous θv*) (3)

When the power factor Pf and the allowable lower power factor Pflo are set in S140, S150, the set power factor Pf and the allowable lower power factor Pflo are compared (S160). Then, when it is determined that the power factor Pf is equal to or larger than the allowable lower limit power factor Pflo, the power factor Pf is set to the control power factor Pf* (S170), and the power factor limit flag Fp is set to 0 (S180). On the other hand, when it is determined that the power factor Pf is less than the allowable lower limit power factor Pflo, the allowable lower limit power factor Pflo is set to the control power factor Pf* (S190), and the power factor limit flag Fp is set to 1 (S200). That is, in S160 to S200 process, a larger one of the power factor Pf and the allowable lower limit power factor Pflo (a value obtained by guarding the power factor Pf with the allowable lower limit power factor Pflo) is set to the control power factor Pf*. When the power factor Pf is less than the allowable lower-limit power factor Pflo (when the allowable lower-limit power factor Pflo larger than the power factor Pf is set to the control power factor Pf*), the power factor limit flag Fp is set to 1.

Subsequently, as shown in Equation (4), the current amplitude I of the applied current of the motor 22 is obtained using the current Id, Iq of the d-axis and the q-axis Operation (S210) is performed. Then, as shown in Equation (5), current amplitude I The effective current Ia is calculated as the product of the control power factor Pf* (S220). Then, as shown in Equation (6), a feedback control for canceling the difference between the effective current Ia and the effective current command Ia* is used to calculate the voltage-phase command θv* (S230), and the routine ends. In Equation (6), “Kp” is the gain of the proportional term, and “Ki” is the gain of the integral term. When the voltage phase command θv* is set in this manner, the switching control of the transistor T11 to T16 of the inverter 24 is performed using the set voltage phase command θv*.

$$\vert I \vert = √ ( {Id}^{2} + {I q}^{2} ) \qquad ( 4 )$$

$$Ia = \vert I \vert \cdot {Pf}^{*} \qquad ( 5 )$$

$${θ v}^{*} = Kp \cdot ( {Ia}^{*} - Ia ) + Ki \cdot \int ( {Ia}^{*} - Ia ) dt \qquad ( 6 )$$

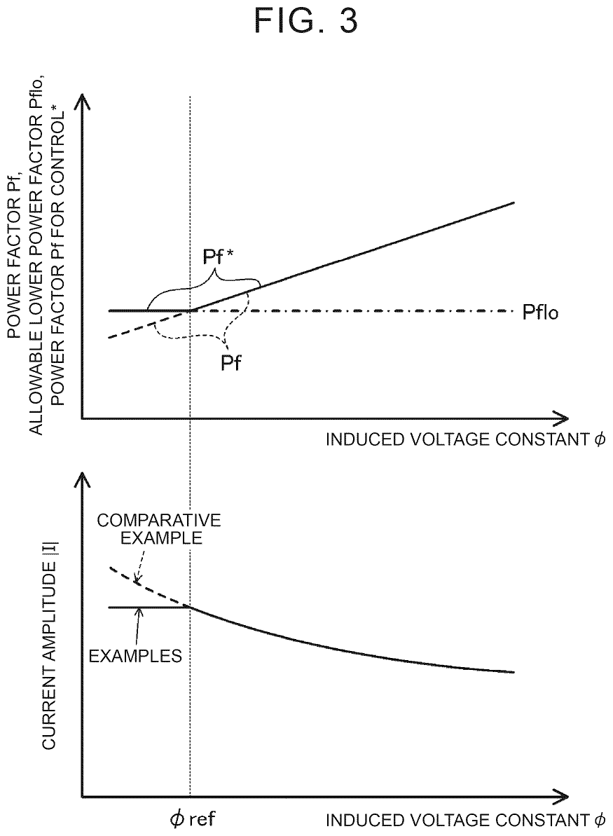

FIG. 3 shows the induced voltage-constant φ and power-factor Pf, the allowable lower power-factor Pflo, the power-factor Pf for control*, and the current amplitude |I| Is an explanatory diagram showing an example of the relationship with. The upper diagram of FIG. 3 shows an exemplary relation between the induced voltage constant and the power factor Pf, the allowable lower limit power factor Pflo, and the control power factor Pf*, and the lower diagram of FIG. 3 shows the induced voltage constant and the current amplitude |I| An example of the relationship with. Incidentally, the induced voltage constant q tends to decrease as the temperature am of the motor 22 increases. In the upper drawing of FIG. 3 and the lower drawing of FIG. 3, “φref” is an induced voltage constant q when the power factor Pf and the allowable lower limit power factor Pflo are the same. In the lower view of FIG. 3, the solid line indicates the current amplitude |I| of the embodiment. The broken line is the current amplitude I of the comparative example. In the comparative example, without using the allowable lower limit power factor Pflo, the control power factor Pf* of Equation (5) is replaced with the power factor Pf, and the current amplitude I is obtained. It is assumed that the operation is performed. As shown in the upper figure of FIG. 3 and the lower figure of FIG. 3, in the comparative example, when the induced voltage constant φ becomes less than the value φref, the power factor Pf becomes sufficiently small, and the current amplitude |I| for feedback control Can be large enough. When the induced voltage constant φ becomes less than the value φref, that is, when the temperature am of the motor 22 becomes higher than a certain value. Current amplitude |I| If it is sufficiently large, the degree of overheating of the motor 22 (demagnetization of the permanent magnets of the motor) may increase. On the other hand, in the embodiment, when the induced-voltage constant φ becomes less than the value φref, the allowable lower-limit power factor Pf larger than the power factor Pflo is set to the control power factor Pf*. As a result, the power factor Pf* for control is suppressed from being sufficiently small, and the current amplitude |I| can be suppressed from becoming sufficiently large for feedback control. As a result, the degree of overheating of the motor 22 (demagnetization of the permanent magnet of the motor) can be suppressed.

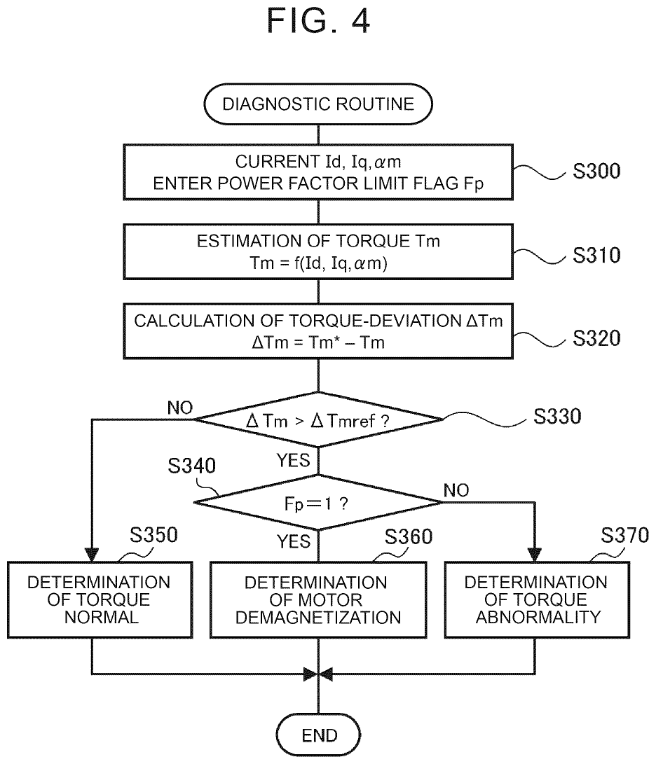

Next, diagnosis of the motor 22 and the inverter 24 will be described. FIG. 4 is a flowchart illustrating an exemplary diagnostic routine executed by ECU 50. This routine is repeatedly executed in parallel with the square wave control routine of FIG. 2. When this routine is executed, ECU 50 first receives the current Id, Iq of the d-axis and the q-axis, the temperature am, and the power factor limit flag Fp (S300).

Subsequently, the torque Tm of the motor 22 is estimated using the current Id, Iq of the d-axis and the q-axis, the temperature am, and the estimated torque map (S310). Here, the estimated torque map is determined in advance by experimentation, analysis, or the like as a relation between the current Id, Iq of the d-axis and the q-axis, the temperature am, and the torque Tm. Specifically, the estimated torque map is determined based on Expression (7) which is a relational expression between the current Id, Iq of the d-axis and the q-axis, the pole logarithm Pn of the rotor of the motor 22, the induced voltage constant q, the d-axis, and the inductance Ld, Lq of the q-axis and the torque Tm. The inductance Ld, Lq of the induced voltage-constant φ, the d-axis, and the q-axis depend on the temperature am of the motor 22. In S310 process, the torque Tm is estimated by applying the current Id, Iq and the temperature am of the d-axis and the q-axis to the estimated torque map and deriving the corresponding torque Tm from the map.

$$Tm = Pn \cdot ( φ \cdot Iq + ( Ld - Lq ) \cdot Id \cdot Iq ) \qquad ( 7 )$$

When the torque Tm of the motor 22 is estimated in this way, the torque deviation ΔTm is calculated by subtracting the torque Tm from the torque command Tm*(S320), and the calculated torque deviation ΔTm is compared with the thresholds ΔTmref (S330). Here, the threshold value ΔTm is a threshold value used for determining whether or not the torque deviation ΔTm is within an allowable range, and is determined in advance by an experiment, an analysis, or the like. When it is determined that the torque deviation ΔTm is equal to or less than the threshold ΔTmref, it is determined that the torque Tm of the motor 22 is normal (S350), and the routine ends.

When it is determined in S330 that the torque-deviation ΔTm is larger than the threshold value ΔTmref, the power-factor limit flag Fp is checked (S340). This process is a process of determining whether or not the torque error ΔTm is larger than the threshold ΔTmref due to the power factor Pf being smaller than the allowable lower limit power factor Pflo (the allowable lower limit power factor Pflo larger than the power factor Pf is set to the control power factor Pf*). That is, it is determined whether or not the torque deviation ΔTm is larger than the threshold value ΔTmref due to demagnetization of the permanent magnet of the motor 22. When it is determined that the power factor limit flag Fp is 1, it is determined that the permanent magnets of the motor 22 are demagnetized (S360), and the routine ends. On the other hand, when it is determined that the power factor limit flag Fp is 0, it is determined that the torque of the motor 22 is abnormal (S370), and the routine ends. Factors in this case include abnormalities of some type of sensor. In this way, the demagnetization of the permanent magnet of the motor 22 and the torque abnormality of the motor 22 can be determined.

In the drive device mounted in battery electric vehicle 10 of the embodiment described above, the rectangular wave control for controlling the inverter 24 by calculating the voltage-phase command θv* using the feedback control for canceling the difference between the effective current Ia and the effective current command Ia*. In this case, the power factor Pf is calculated based on the current phase θi based on the current Id, Iq of the d-axis and the q-axis and the previous value of the voltage-phase command θv*. The calculated power factor Pf is guarded at the lower limit of the allowable power factor Pflo to set the control power factor Pf*. Then, the current amplitude I based on the current Id, Iq of the d-axis and the q-axis The effective current Ia is calculated as the product of the control power factor Pf*. Thus, even if the temperature am of the motor 22 increases (even if the induced voltage constant φ decreases), the control power factor Pf* is sufficiently reduced, and the current amplitude |I| can be suppressed from becoming sufficiently large for feedback control. As a result, the degree of overheating of the motor 22 (demagnetization of the permanent magnet of the motor) can be suppressed.

Further, in the drive device of the embodiment, when the torque deviation ΔTm obtained by subtracting the torque Tm from the torque command Tm* is larger than the threshold ΔTmref, when the power factor Pf is less than the allowable lower limit power factor Pflo, it is determined that the demagnetization of the permanent magnets of the motor 22. The case where the power factor Pf is less than the allowable lower limit power factor Pflo is a case where the allowable lower limit power factor Pflo larger than the power factor Pf is set to the control power factor Pf*. In this way, demagnetization of the permanent magnets of the motor 22 can be detected.

In the above-described embodiment, the rotational speed Nm of the motor 22, the torque command Tm* and the voltage amplitude V| Although the allowable lower power factor Pflo is set by using and, the present disclosure is not limited thereto. For example, the rotational speed Nm, the torque command Tm* and the voltage amplitude |V| An allowable lower-limit power factor Pflo may be set using a portion of. In addition, the allowable lower limit power factor Pflo may be set considering the temperature am of the motor 22.

In the above-described embodiment, when the torque deviation ΔTm obtained by subtracting the torque Tm from the torque command Tm* is larger than the threshold ΔTmref, the demagnetization of the permanent magnets of the motor 22 and the torque anomaly of the motor 22 are determined based on whether or not the power factor Pf is less than the allowable lower limit power factor Pflo. However, such a determination may not be performed. Whether or not the power factor Pf is less than the allowable lower limit power factor Pflo can be replaced with whether or not any of the power factor Pf and the allowable lower limit power factor Pflo is set to the control power factor Pf*.

In the above-described embodiment, the drive device mounted on battery electric vehicle 10 including the motor 22 and the inverter 24 is configured, but the present disclosure is not limited thereto. For example, it may be in the form of a drive device mounted on a hybrid electric vehicle that further comprises an engine in addition to the motor and the inverter. Further, the drive device may be mounted on a fuel cell electric vehicle that further includes a fuel-cell in addition to the motor and the inverter.

The correspondence between the main elements of the embodiments and the main elements of the disclosure described in the column of the means for solving the problem will be described. In the embodiment, the motor 22 corresponds to the “motor”, the inverter 24 corresponds to the “inverter”, and ECU 50 corresponds to the “control device”.

The correspondence between the main elements of the embodiment and the main elements of the disclosure described in the section of the means for solving the problem is an example for specifically explaining the embodiment of the disclosure described in the section of the means for solving the problem. The correspondence between the main elements of the embodiments and the main elements of the disclosure is not intended to limit the elements of the disclosure described in the section of the means for solving the problem. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of a drive device and the like.

What is claimed is:

1. A drive device comprising:
a motor;
an inverter that drives the motor; and
a control device that controls the inverter through rectangular wave control by setting an effective current command based on a torque command and a rotational speed of the motor and a direct current-side voltage of the inverter and setting a voltage phase command using feedback control for canceling out a difference between the effective current command and an effective current, wherein the control device sets a control power factor by guarding a lower limit of a power factor based on a current phase and a voltage phase using an allowable lower limit power factor, and calculates the effective current as a product of a current amplitude based on d-axis and q-axis currents and the control power factor.

2. The drive device according to claim 1, wherein the control device sets the allowable lower limit power factor based on a voltage amplitude of the motor based on the direct current-side voltage, the torque command, and the rotational speed.

3. The drive device according to claim 1, wherein when the torque command is Tm*, the rotational speed is Nm, a voltage amplitude of the motor based on the direct current-side voltage is |V|, the effective current command is Ia*, the d-axis and q-axis currents are Id, Iq, the current phase is θi, the voltage phase command is θv*, the power factor is Pf, and the current amplitude is |I|, the control device
calculates the effective current command Ia* according to equation (A),
calculate the current phase θi according to equation (B),
calculate the power factor Pf according to equation (C), and
calculate the current amplitude |I| according to equation (D):
$${Ia}^{*} = 2 π \cdot Nm \cdot {Tm}^{*} / ( 60 \cdot \vert V \vert ) \qquad ( A )$$
$$θ i = {tan}^{- 1} ( Id / Iq ) \qquad ( B )$$
$$Pf = cos ( θ i - previous {θ v}^{*} ) \qquad ( C )$$
$$\vert I \vert = √ ( {Id}^{2} + {I q}^{2} ) . \qquad ( D )$$

4. The drive device according to claim 1, wherein when a torque deviation obtained by subtracting torque of the motor from the torque command is larger than a predetermined deviation, the control device determines demagnetization of a permanent magnet of the motor when the power factor is less than the allowable lower limit power factor.
